(19) United States
(12) Patent Application Publication
(10) Pub. No.: US 2025/0150540 A1
(43) Pub. Date: May 8, 2025

(54) CHARGING THIRD PARTIES FOR ACCESS TO MANAGEMENT SERVICES

(71) Applicant: Lenovo (Singapore) Pte. Ltd., New Tech Park (SG)

(72) Inventors: Ishan Vaishnavi, München (DE); Emmanouil Pateromichelakis, Viersen (DE)

(21) Appl. No.: 18/837,506

(22) PCT Filed: Mar. 23, 2022
(86) PCT No.: PCT/EP2022/057712

§ 371 Date: Aug. 9, 2024

(30) Foreign Application Priority Data
Feb. 11, 2022 (GR) 20220100134

(51) Int. Cl. H04M 15/00

(52) U.S. Cl. CPC H04M 15/41; H04M 15/82

(57) ABSTRACT

Various aspects of the present disclosure relate to charging third parties for access to management services. An apparatus is configured to receive a first event notification for generating a charging data record (“CDR”). The apparatus is configured to generates the CDR in response to the first event notification, the CDR comprising information associated with access to a management service. The apparatus is configured to transmits a second event notification comprising the generated CDR.

### FIELD

The subject matter disclosed herein relates generally to wireless communications and more particularly relates to charging third parties for access to management services.

### BACKGROUND

In certain wireless communication systems, a User Equipment device (“UE”) is able to connect with a fifth-generation (“5G”) core network (i.e., “5GC”) in a Public Land Mobile Network (“PLMN”). In wireless networks, access to management services may be billed to consumers. The ability of an operator to charge for the frequency and type of management service access is currently missing in the standards discussion.

### BRIEF SUMMARY

Disclosed are procedures for charging third parties for access to management services. Said procedures may be implemented by apparatus, systems, methods, and/or computer program products.

In one embodiment, a first apparatus includes a transceiver that receives, at a first entity, a first event notification for generating a charging data record (“CDR”) from a second entity of the communication network, the first event notification received in response to access to a management service of the communication network. In one embodiment, the first apparatus includes a processor that generates, at the first entity, the CDR in response to the first event notification, the CDR comprising information associated with access to the management service of the communication network. In one embodiment, the transceiver transmits, to the second entity, a second event notification comprising the generated CDR.

In one embodiment, a first method includes receiving, at a first entity, a first event notification for generating a charging data record (“CDR”) from a second entity of the communication network, the first event notification received in response to access to a management service of the communication network. In one embodiment, the first method includes generating, at the first entity, the CDR in response to the first event notification, the CDR comprising information associated with access to the management service of the communication network. In one embodiment, the first method includes transmitting, to the second entity, a second event notification comprising the generated CDR.

In one embodiment, a second apparatus includes a transceiver transmits, to an entity of the communication network, a first event notification for generating a charging data record (“CDR”), the first event notification transmitted in response to access to a management service of the communication network. In one embodiment, the transceiver receives a second event notification comprising a generated CDR, the CDR comprising information associated with access to the management service of the communication network.

In one embodiment, a second method includes transmitting, to an entity of the communication network, a first event notification for generating a charging data record (“CDR”), the first event notification transmitted in response to access to a management service of the communication network. In one embodiment, the second method includes receiving a second event notification comprising a generated CDR, the CDR comprising information associated with access to the management service of the communication network.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for charging third parties for access to management services;

FIG. 2 is depicts one example of management service and component type A, B and C for charging third parties for access to management services;

FIG. 3 depicts one example of management capability exposure governance applied on an exposed management service for charging third parties for access to management services;

FIG. 4A depicts one example of vertical charging for charging third parties for access to management services;

FIG. 4B depicts one example of vertical charging for charging third parties for access to management services;

FIG. 5 depicts one example procedure for charging trigger function-based management data charging for charging third parties for access to management services;

FIG. 6 depicts one example procedure for charging enablement function-based management data charging for charging third parties for access to management services;

FIG. 7 is a block diagram illustrating one embodiment of a user equipment apparatus that may be used for charging third parties for access to management services;

FIG. 8 is a block diagram illustrating one embodiment of a network apparatus that may be used for charging third parties for access to management services;

FIG. 9 is a flowchart diagram illustrating one embodiment of a method for charging third parties for access to management services; and

FIG. 10 is a flowchart diagram illustrating one embodiment of another method for charging third parties for access to management services.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for charging third parties for access to management services. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

In the 3^{rd} generation partnership project (“3GPP”) service and system aspects (“SA5”) management service exposure always goes via the business support systems (“BSS”). This is to ensure that the management service (“MnS”) access is properly billed and managed according to the service level specification (“SLS”) agreements as the exposure is towards an external customer (this implies that there is a business relationship). An exposure through the BSS typically provides access to business level APIs (like those specified by TM Forum (“TMF”)). However, there is agreement in SA5 that when the operator and the external consumer agree to the exposure of the raw network management level APIs, or in other words management service producers (“MnS producers”), the external consumer may be charged for access to the APIs. In this case, how the charging is performed for the number and/or frequency of MnS access is currently not addressed.

Management services from the operator maybe exposed to both: (i) entities external to the management domain as well as (ii) entities external to the operator network. TR 28.824 states that the exposure predominantly goes via the BSS unless there is an agreement between the operator and the consumer to directly consume management services. A direct network management level exposure may exist based on customer agreement. An example of this is in cases where one network operator is accessing another network operator's management services to create a federated network (e.g., a pan European network, or a 3GPP core and RAN network operator utilizing services of an edge network operator).

In addition, the MnS may be exposed to trusted applications that are external to the management domain or the operator's network, and act as middleware entities between the 5GS and the end customer (e.g., application service provider (“ASP”) or vertical). Such enablement layer has been defined in 3GPP SA6 to provide value-added services to ease the management capability exposure to the verticals. This enablement layer may be deployed by the mobile network operator (“MNO”), or an edge/cloud service provider, or a third-party provider that consumes the MnS and re-sells them as abstracted/simplified services.

Currently there is no way to support a charging model for MnS usage in the standards. The ability of an operator to charge for the frequency and type of MnS access is currently missing in the standards discussion. In one embodiment, this disclosure describes solutions that provide the ability for an operator to charge based on the number or type of MnS producer access. Furthermore, this disclosure provides solutions that leverage the ability of the operator to charge for the number of times an MnS is access thereby increasing the motivation for operators to provide such access to third parties. Such an access is fundamental to the promises of 5G to the verticals.

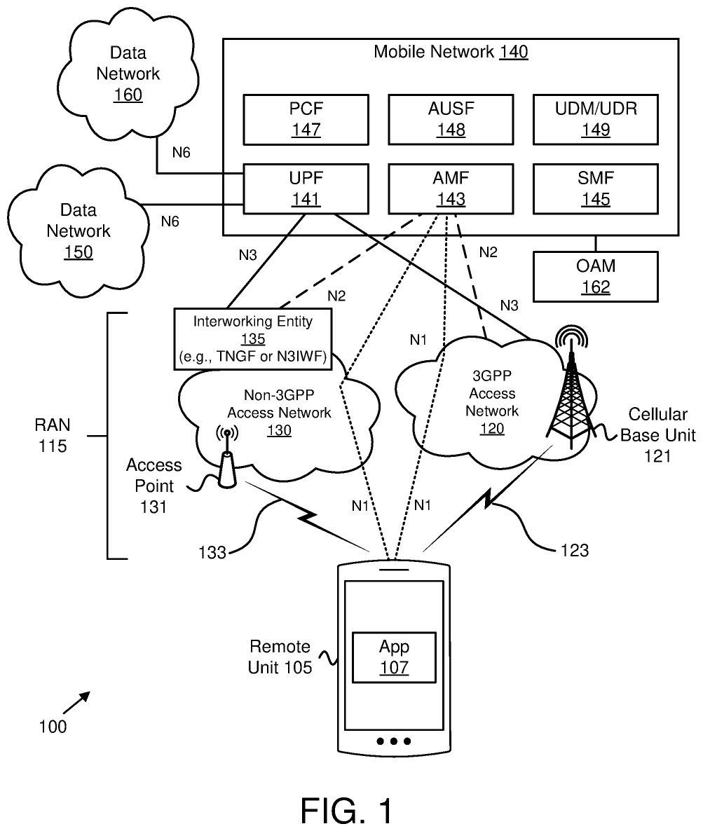

FIG. 1 depicts a wireless communication system 100 for charging third parties for access to management services, according to embodiments of the disclosure. In one embodiment, the wireless communication system 100 includes at least one remote unit 105, a Fifth-Generation Radio Access Network (“5G-RAN”) 115, and a mobile core network 140. The 5G-RAN 115 and the mobile core network 140 form a mobile communication network. The 5G-RAN 115 may be composed of a 3GPP access network 120 containing at least one cellular base unit 121 and/or a non-3GPP access network 130 containing at least one access point 131. The remote unit 105 communicates with the 3GPP access network 120 using 3GPP communication links 123 and/or communicates with the non-3GPP access network 130 using non-3GPP communication links 133. Even though a specific number of remote units 105, 3GPP access networks 120, cellular base units 121, 3GPP communication links 123, non-3GPP access networks 130, access points 131, non-3GPP communication links 133, and mobile core networks 140 are depicted in FIG. 1, one of skill in the art will recognize that any number of remote units 105, 3GPP access networks 120, cellular base units 121, 3GPP communication links 123, non-3GPP access networks 130, access points 131, non-3GPP communication links 133, and mobile core networks 140 may be included in the wireless communication system 100.

In one implementation, the RAN 120 is compliant with the 5G system specified in the Third Generation Partnership Project (“3GPP”) specifications. For example, the RAN 120 may be a NG-RAN, implementing NR RAT and/or LTE RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as UEs, subscriber units, mobiles, mobile stations, users, terminals, mobile terminals, fixed terminals, subscriber stations, user terminals, wireless transmit/receive unit (“WTRU”), a device, or by other terminology used in the art.

The remote units 105 may communicate directly with one or more of the cellular base units 121 in the 3GPP access network 120 via uplink (“UL”) and downlink (“DL”) communication signals. Furthermore, the UL and DL communication signals may be carried over the 3GPP communication links 123. Similarly, the remote units 105 may communicate with one or more access points 131 in the non-3GPP access network(s) 130 via UL and DL communication signals carried over the non-3GPP communication links 133. Here, the access networks 120 and 130 are intermediate networks that provide the remote units 105 with access to the mobile core network 140.

In some embodiments, the remote units 105 communicate with a remote host (e.g., in the data network 150 or in the data network 160) via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the 5G-RAN 115 (i.e., via the 3GPP access network 120 and/or non-3GPP network 130). The mobile core network 140 then relays traffic between the remote unit 105 and the remote host using the PDU session. The PDU session represents a logical connection between the remote unit 105 and a User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. Additionally-or alternatively-the remote unit 105 may have at least one PDU session for communicating with the packet data network 160. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

As described in greater detail below, the remote unit 105 may use a first data connection (e.g., PDU Session) established with the first mobile core network 130 to establish a second data connection (e.g., part of a second PDU session) with the second mobile core network 140. When establishing a data connection (e.g., PDU session) with the second mobile core network 140, the remote unit 105 uses the first data connection to register with the second mobile core network 140.

The cellular base units 121 may be distributed over a geographic region. In certain embodiments, a cellular base unit 121 may also be referred to as an access terminal, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a Home Node-B, a relay node, a device, or by any other terminology used in the art. The cellular base units 121 are generally part of a radio access network (“RAN”), such as the 3GPP access network 120, that may include one or more controllers communicably coupled to one or more corresponding cellular base units 121. These and other elements of radio access network are not illustrated but are well known generally by those having ordinary skill in the art. The cellular base units 121 connect to the mobile core network 140 via the 3GPP access network 120.

The cellular base units 121 may serve a number of remote units 105 within a serving area, for example, a cell or a cell sector, via a 3GPP wireless communication link 123. The cellular base units 121 may communicate directly with one or more of the remote units 105 via communication signals. Generally, the cellular base units 121 transmit DL communication signals to serve the remote units 105 in the time, frequency, and/or spatial domain. Furthermore, the DL communication signals may be carried over the 3GPP communication links 123. The 3GPP communication links 123 may be any suitable carrier in licensed or unlicensed radio spectrum. The 3GPP communication links 123 facilitate communication between one or more of the remote units 105 and/or one or more of the cellular base units 121. Note that during NR operation on unlicensed spectrum (referred to as “NR-U”), the base unit 121 and the remote unit 105 communicate over unlicensed (i.e., shared) radio spectrum.

The non-3GPP access networks 130 may be distributed over a geographic region. Each non-3GPP access network 130 may serve a number of remote units 105 with a serving area. An access point 131 in a non-3GPP access network 130 may communicate directly with one or more remote units 105 by receiving UL communication signals and transmitting DL communication signals to serve the remote units 105 in the time, frequency, and/or spatial domain. Both DL and UL communication signals are carried over the non-3GPP communication links 133. The 3GPP communication links 123 and non-3GPP communication links 133 may employ different frequencies and/or different communication protocols. In various embodiments, an access point 131 may communicate using unlicensed radio spectrum. The mobile core network 140 may provide services to a remote unit 105 via the non-3GPP access networks 130, as described in greater detail herein.

In some embodiments, a non-3GPP access network 130 connects to the mobile core network 140 via an interworking entity 135. The interworking entity 135 provides an interworking between the non-3GPP access network 130 and the mobile core network 140. The interworking entity 135 supports connectivity via the “N2” and “N3” interfaces. As depicted, both the 3GPP access network 120 and the interworking entity 135 communicate with the AMF 143 using a “N2” interface. The 3GPP access network 120 and interworking entity 135 also communicate with the UPF 141 using a “N3” interface. While depicted as outside the mobile core network 140, in other embodiments the interworking entity 135 may be a part of the core network. While depicted as outside the non-3GPP RAN 130, in other embodiments the interworking entity 135 may be a part of the non-3GPP RAN 130.

In certain embodiments, a non-3GPP access network 130 may be controlled by an operator of the mobile core network 140 and may have direct access to the mobile core network 140. Such a non-3GPP AN deployment is referred to as a “trusted non-3GPP access network.” A non-3GPP access network 130 is considered as “trusted” when it is operated by the 3GPP operator, or a trusted partner, and supports certain security features, such as strong air-interface encryption. In contrast, a non-3GPP AN deployment that is not controlled by an operator (or trusted partner) of the mobile core network 140, does not have direct access to the mobile core network 140, or does not support the certain security features is referred to as a “non-trusted” non-3GPP access network. An interworking entity 135 deployed in a trusted non-3GPP access network 130 may be referred to herein as a Trusted Network Gateway Function (“TNGF”). An interworking entity 135 deployed in a non-trusted non-3GPP access network 130 may be referred to herein as a non-3GPP interworking function (“N3IWF”). While depicted as a part of the non-3GPP access network 130, in some embodiments the N3IWF may be a part of the mobile core network 140 or may be located in the data network 150.

In one embodiment, the mobile core network 140 is a 5G core (“5GC”) or the evolved packet core (“EPC”), which may be coupled to a data network 150, like the Internet and private data networks, among other data networks. A remote unit 105 may have a subscription or other account with the mobile core network 140. Each mobile core network 140 belongs to a single public land mobile network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF (“UPF”) 141. The mobile core network 140 also includes multiple control plane functions including, but not limited to, an Access and Mobility Management Function (“AMF”) 143 that serves the 5G-RAN 115, a Session Management Function (“SMF”) 145, a Policy Control Function (“PCF”) 146, an Authentication Server Function (“AUSF”) 147, a Unified Data Management (“UDM”) and Unified Data Repository function (“UDR”).

The UPF(s) 141 is responsible for packet routing and forwarding, packet inspection, QoS handling, and external PDU session for interconnecting Data Network (“DN”), in the 5G architecture. The AMF 143 is responsible for termination of NAS signaling, NAS ciphering & integrity protection, registration management, connection management, mobility management, access authentication and authorization, security context management. The SMF 145 is responsible for session management (i.e., session establishment, modification, release), remote unit (i.e., UE) IP address allocation & management, DL data notification, and traffic steering configuration for UPF for proper traffic routing.

The PCF 146 is responsible for unified policy framework, providing policy rules to CP functions, access subscription information for policy decisions in UDR. The AUSF 147 acts as an authentication server.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include an Network Exposure Function (“NEF”) (which is responsible for making network data and resources easily accessible to customers and network partners, e.g., via one or more APIs), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. A network instance may be identified by a S-NSSAI, while a set of network slices for which the remote unit 105 is authorized to use is identified by NSSAI. In certain embodiments, the various network slices may include separate instances of network functions, such as the SMF and UPF 141. In some embodiments, the different network slices may share some common network functions, such as the AMF 143. The different network slices are not shown in FIG. 1 for ease of illustration, but their support is assumed.

Although specific numbers and types of network functions are depicted in FIG. 1, one of skill in the art will recognize that any number and type of network functions may be included in the mobile core network 140. Moreover, where the mobile core network 140 comprises an EPC, the depicted network functions may be replaced with appropriate EPC entities, such as an MME, S-GW, P-GW, HSS, and the like.

While FIG. 1 depicts components of a 5G RAN and a 5G core network, the described embodiments for using a pseudonym for access authentication over non-3GPP access apply to other types of communication networks and RATs, including IEEE 802.11variants, GSM, GPRS, UMTS, LTE variants, CDMA2000, Bluetooth, ZigBee, Sigfoxx, and the like. For example, in an 4G/LTE variant involving an EPC, the AMF 143 may be mapped to an MME, the SMF mapped to a control plane portion of a PGW and/or to an MME, the UPF 141 may be mapped to an SGW and a user plane portion of the PGW, the UDM/UDR 149 may be mapped to an HSS, etc.

The Operations, Administration and Maintenance (“OAM”) 162 is involved with the operating, administering, managing, and maintaining of the system 100. “Operations” encompass automatic monitoring of environment, detecting and determining faults and alerting admins. “Administration” involves collecting performance stats, accounting data for the purpose of billing, capacity planning using Usage data and maintaining system reliability. Administration can also involve maintaining the service databases which are used to determine periodic billing. “Maintenance” involves upgrades, fixes, new feature enablement, backup and restore and monitoring the media health. In certain embodiments, the OAM 162 may also be involved with provisioning, i.e., the setting up of the user accounts, devices, and services.

As depicted, a remote unit 105 (e.g., a UE) may connect to the mobile core network (e.g., to a 5G mobile communication network) via two types of accesses: (1) via 3GPP access network 120 and (2) via a non-3GPP access network 130. The first type of access (e.g., 3GPP access network 120) uses a 3GPP-defined type of wireless communication (e.g., NG-RAN) and the second type of access (e.g., non-3GPP access network 130) uses a non-3GPP-defined type of wireless communication (e.g., WLAN). The 5G-RAN 115 refers to any type of 5G access network that can provide access to the mobile core network 140, including the 3GPP access network 120 and the non-3GPP access network 130.

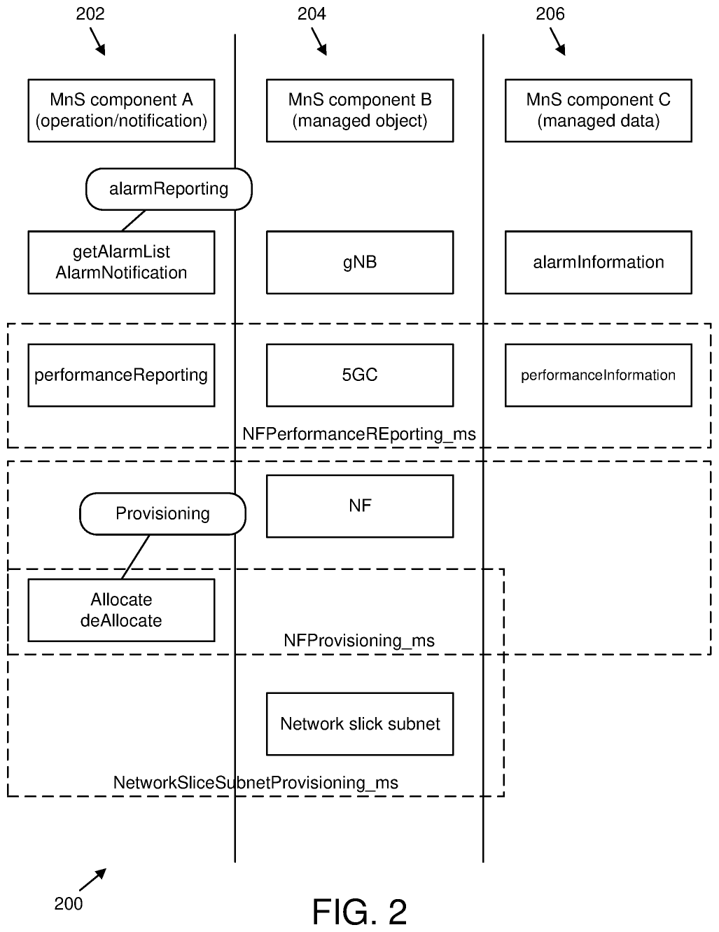

As background, technical specification (“TS”) 28.533 V17.0.0 provides information about background terms and concepts used herein. FIG. 2 depicts one embodiment of management service and component type A, B, and C. In one embodiment, MnS component type B 204 refers to management information represented by information models representing the managed entities. A MnS component type B 204 is also called a Network Resource Model (“NRM”). MnS component type B 204 examples may include:
i. Network resource models, e.g., as defined in TS 28.622.
ii. Network resource models, e.g., as defined in TS 28.541.

MnS component type C 206 is performance information of the managed entity and fault information of the managed entity. The following are examples of MnS type C 206:
i. Alarm information, e.g., as defined in TS 28.532 and TS 28.545.
ii. Performance data, e.g., as defined in TS 28.552, TS 28.554 and TS 32.425.

An MnS producer is described by a set of metadata called a MnS producer profile. The profile holds information about the supported MnS components and their version numbers. This may also include information about support of optional features. For example, a read operation on a complete subtree of managed object instances may support applying filters on the scoped set of objects as optional feature. In this case, the MnS profile should include the information if filtering is supported.

An MnS is composed of a MnS component type A 202 and either a MnS component type B 202, or a MnS component type B 204 and a MnS component type C 206. The instances of management services carry information about specified management service components in the metadata attributes.

As a precondition for management service exposure governance offer, producer of management capability exposure governance should have access to an association between information about specified management service components and instances of management services. It is noted that the detail creation of an association is left for implementation and out of scope of 3GPP standardization.

Management capability exposure governance provides exposure governance on basic elements of a management function service-based interface:
i. Management service component type A 202;
ii. Management service component type B 204; and
iii. Management service component type C 206.

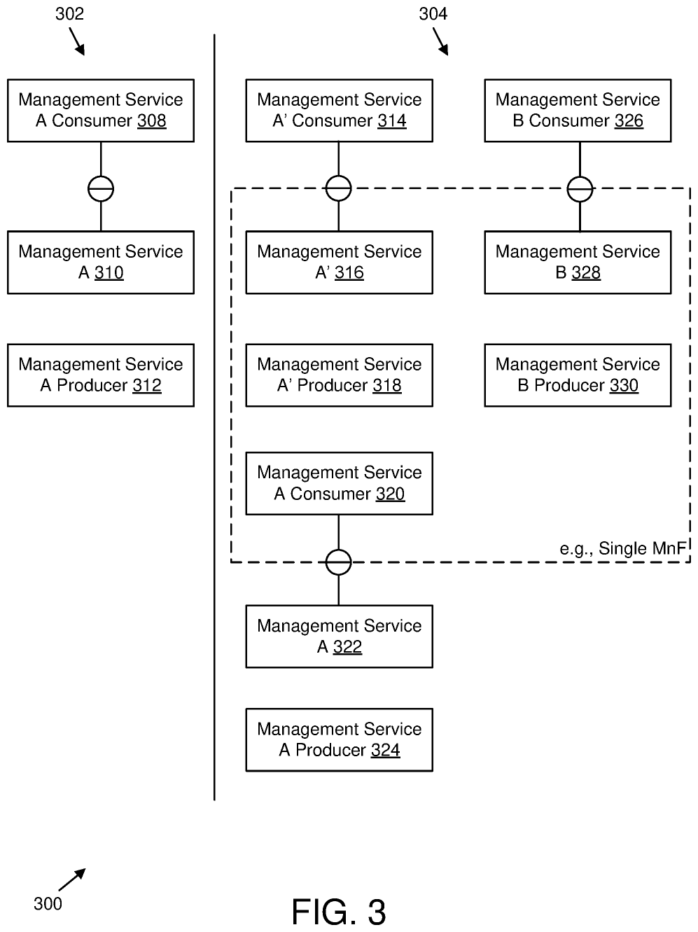

As described in FIG. 3, on the left-hand side 302, when there is a Management Service A 310 exposure without exposure governance, a Management Service A Consumer (e.g., a third party) 308 can access all management capability offered by Management Service A Producer 312.

As described in FIG. 3 right-hand side 304, when Management Service A 322 is exposed with applied exposure governance it becomes Management Service A′ 316. Management Service A′ Consumer 314 can access Management Service A′ 316 after following steps:
i. Management Service A 322, exposed by Management Service A Producer 324, is consumed by Management Service A Consumer 320.
ii. Management Service B 328, exposed by Management Service B Producer 330, is consumed by Management Service B Consumer (e.g., operator) 326 that is authorized to access offered management capabilities exposure governance(s).
iii. Management Service B Consumer (e.g., operator) 326 requests a specified exposure governance on Management Service A 322;
iv. Management Service A′ Producer 318 produces Management Service A′ 316 based on applied exposure governance on consumed Management Service A 322.

It is noted that he Management Service A Consumer 320, the Management Service A′ Producer 318 and Management Service B Producer 330 can be represented as a single Management Function (“MnF”).

Conventional solutions allow for direct external access to the Network Management Layer (“NML”). The following scenarios illustrate this situation, e.g., and may be documented in TR 28.824 v0.4.0 section 4.1.1.4.2, in particular:
i. Scenario 1: The network operator and the network service provider roles are played by the same operator; and
ii. Scenario 2: Network services platform (“NSP”) and network operator (“NOP”) as different companies.

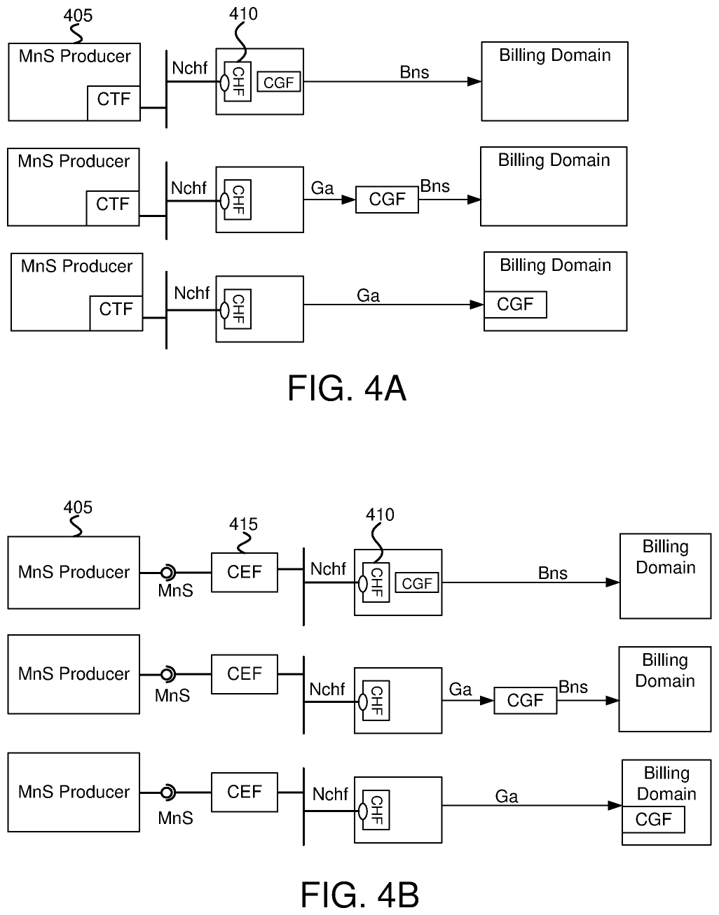

However, an alternative possibility to access the management service is directly if a business agreement is in place to allow such access (e.g., this is shown is FIG. 4.1.1.3.2-1 in TR 28.824 v0.4.0 where external seal server or AF can access the MnS's that are exposed according to a pre-existing contract).

Such an exposure may involve charges for access management services. In the charging work TS 28.202, charging for MnS producer for managing Network Slice instances is specified.

The two architectural options are shown in FIGS. 4A (charging trigger function (“CTF”) based) and 4B (charging enablement function (“CEF”) based) and are descried in more detail in Section 4.2.2. of TS 28.202.

While the two options are conceptually identical, there is a difference in the impact for standardization. The essence of both options is that the MnS producer 405 reports the relevant KPIs and other parameters, such as those relevant for classification of charging, directly to the charging function (“CHF”) 410 in option 1, whereas in option 2 the CEF 415 gather those details from the MnS producers 405. The current specification supports both options for charging the MnS consumer for Network Slice Instance (“NSI”) creation, modification, and/or termination. NSI is defined in TS 28.530.

MnS producer access may not be relevant only to NSI management, but it could also refer to network slice subnet instance (“NSSI”), network functions (“NF”), virtual infrastructure, or even physical infrastructure management.

In one embodiment, the solutions proposed herein have the NML record chargeable data on a per-authentication or per-group of authentication basis and periodically report it to the business system for billing. To do this, the billing system or the operator may configure charging in the exposure system (e.g., for external consumers) or on each MnS producer (e.g., for internal or external exposure).

The reporting chargeable data could include any combination of:
i. number of times an operation of a management service is used;
ii. the details of MnS access, for example, if a subscription to periodic notification, data or insights is used;
iii. any changes in MnS request;
iv. any management details such as the exact managed object instances (“MOIs”), fully qualified domain names (“FQDNs”), master information blocks (“MIBS”), and key performance indicators (“KPIs”) that are requested; and/or
v. incorrect or incompatible MnS requests that may have caused network/performance issues/errors.

The embodiments described below primarily relate to access to MnS component A or operations in MnS component A or corresponding combination of MnS component A operation with the MnS component B it applies to. SA5 supports CTF and CEF based solutions for charging. CTF-based is when the entity reporting information relating to charging inherently supports charging triggers, e.g., it can trigger the collection of charging reports in the CHF. A CEF based solution is when a centralized function collects data that may be relevant to one or more charging reports and may trigger a joint charging data trigger to the CHF.

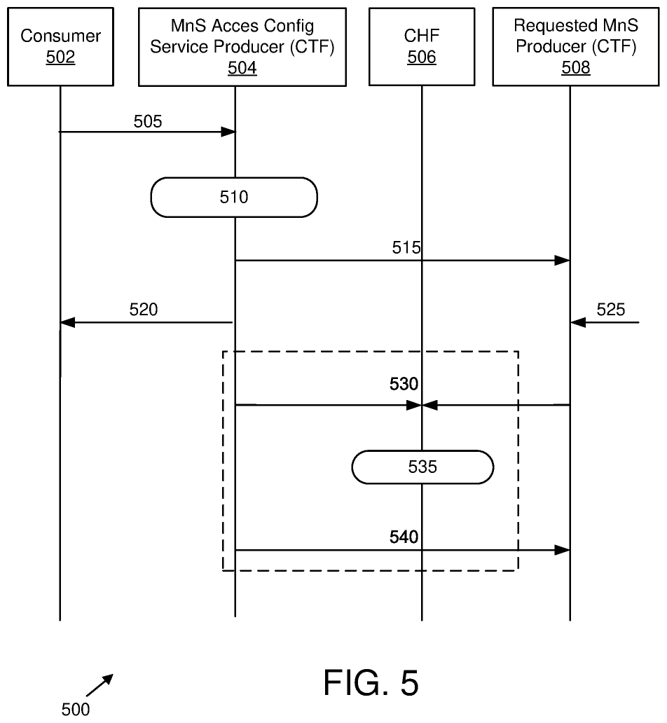

FIG. 5 depicts a first embodiment of a procedure 500 for CTF-based management data charging. In one embodiment, the procedure 500 includes a consumer 502, an MnS access configuration service producer (CTF) 504, a CHF 506, and the requested MnS producer (CTF) 508.

In one embodiment, at step 1, an authenticated entity or consumer 502 requests (see messaging 505) a new or a different MnS 508, access to a MnS component B for a given component A, an entirely new operation of MnS component A, or a combination of MnS component A operation in association with MnS component B from the (exposure) MnS Access Config service producer 504 (e.g., provisioning service access so that the consumer 502 can change a particular attribute of an MOI).

In one embodiment, at step 2, the MnS Access Config service producer 504 optionally looks for authorization approval (see block 510) from the appropriate authorization entity. This may require a check of the authenticated entities' authorization based on existing business agreements such as service level agreements (“SLAs”), service level specifications (“SLSs”), generic network slice templates (“GSTs”), network slice type (“NEST”), ServiceProfile, and NetworkSlice profile.

In one embodiment, at step 3, if approved, the MnS service producer 504 may optionally configure (see messaging 515) the change of access in the appropriate MnS producer or MOI 508. This may include configuration of the corresponding CTF in the requested MnS producer 508. the access configuration could alternatively be done via the MnS producer responsible for authentication or authorization.

In one embodiment, at step 4, a response (see messaging 520) indicating success or failure is provided. In case of success, information may be included in the response such as approved access to the MnS producers 508 or information on where to subscribe for accessing the MnS producers 508.

In one embodiment, at step 5, based on the new access configured in step 3, the MnS Producer 508 is accessed/used (see messaging 525) by the respective authorization.

In one embodiment, at step 6, at the CHF 506, a charging data record (“CDR”) event notification is generated and received (see messaging 530), a CDR is created in response to the CDR event notification (see block 535), and a reply event is generated (see messaging 540), which may be either when the new configuration is configured or when the data is accessed. The CDR report may include:
i. the number of times an MnS component A operation or the MnS component B was accessed over a time interval;
ii. any changes requested for accessing MnS component A operation, or corresponding MnS component B, and the number of times those changes were requested;
iii. the details of the MnS access, for example, if a subscription to periodic notification, data, or insights is used; and
iv. any further MnS access details such as the exact MOIs, FQDNs, MIBs, or KPIs that are requested.

In one embodiment, the CHF 506 may store this information appropriately subject to local regulations. The CHF in step 6, or later, based on its own policies, may decide to send the information to the BSS, which then uses the CDRs to create billing information for the account associated to the consumer 502.

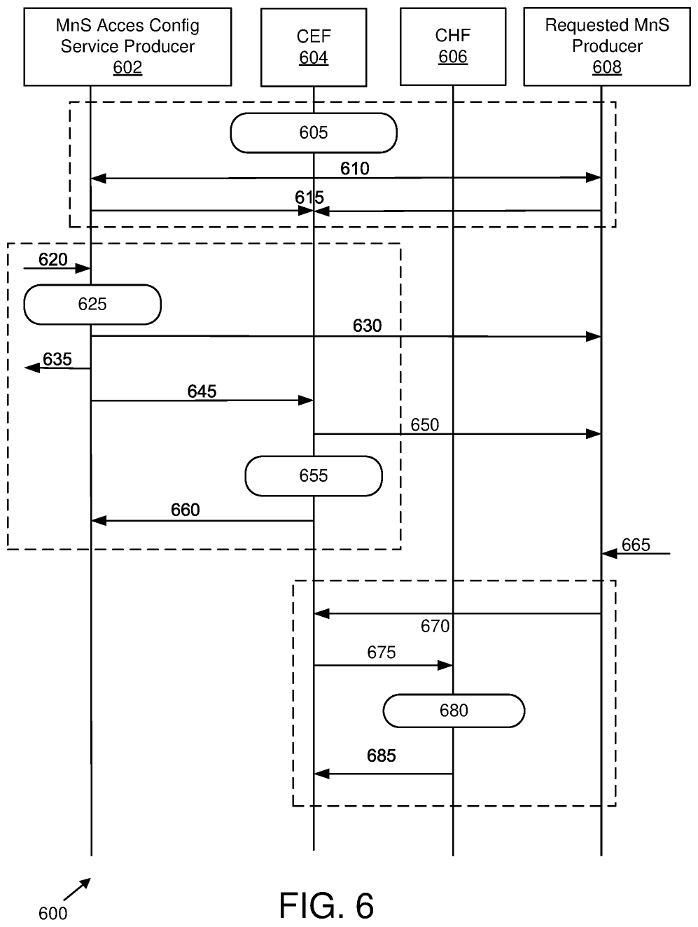

FIG. 6 depicts a first embodiment of a procedure 600 for CTF-based management data charging. In one embodiment, the procedure 600 includes an MnS access configuration service producer 602, a CEF 604, a CHF 606, and the requested MnS producer 608.

In one embodiment, steps 1 through 3 depict a CEF subscription to MnS producer, e.g., as described in TS28.202. At step 1, the CEF 604 determines (see block 605) to subscribe to an MnS. At step 2, the CEF 604 sends a subscribe request (see messaging 610) to the MnS Access Config Service Producer 602 and the Requested MnS Producer 608. At step 3, the CEF 604 receives subscribe responses (see messaging 615) from the MnS Access Config Service Producer 602 and the Requested MnS Producer 608.

In one embodiment, at step 4, an authenticated entity requests (see messaging 620) new or different management service component A access associated typically with MnS component B from the MnS service producer 602 (e.g., for the ability to provision (MnS component A) a Network Slice Instance (MnS component B)).

In one embodiment, at step 5a, the MnS Access Config Service Producer 602 checks (see block 625) for authorization approval from the appropriate authorization entity. At step 5b, in one embodiment, the MnS service producer 602 may configure (see messaging 630) the change of access in the appropriate MnS producer 608 or corresponding MOI (e.g., the appropriate instance of the provision MnS producer and/or the Network Slice Instance MOI associated with the requested NSI ID). This step may be an alternative to step 7b.

In one embodiment, at step 6, a response indicating success or failure is provided (see messaging 635). In case of success, the response includes information such as approved access to the MnS producers and/or information on where to access the MnS producers.

In one embodiment, at step 7a, a notification is sent (see messaging 645) to the CEF 604 of the access change. At step 7b, in one embodiment, which may be the same as step 5b, the CEF 604 configures (see messaging 650) the change of access in the appropriate MnS producer 608 or corresponding MOI (e.g., the appropriate instance of the provision MnS producer and/or the Network Slice Instance MOI associated with the requested NSI ID). One of steps 5b and 7b may be performed.

At step 7c, in one embodiment, subscription to the new MnS changes is performed (see block 655) (e.g., repeating steps 1-3).

In one embodiment, at step 8, a response for the notification sent is step 7a is provided (see messaging 660).

In one embodiment, at step 9, the newly configured MnS 608 in step 5b or step 7b is used or accessed (see messaging 665) by the corresponding authorization.

In one embodiment, at step 10, a report of the MnS access is provided (see messaging 670) to the CEF 604 from the MnS 608. This may be based on configuration in step 1-3 or 7b.

In one embodiment, at step 11, at the CHF 506, a charging data record (“CDR”) event notification is generated and received (see messaging 675), a CDR is created in response to the CDR event notification (see block 680), and a reply event is generated (see messaging 685), which may be either when the new configuration is configured or when the data is accessed. The CDR report may include:
i. the number of times an MnS component A operation or the MnS component B was accessed over a time interval;
ii. any changes requested for accessing MnS component A operation, or corresponding MnS component B, and the number of times those changes were requested;
iii. the details of the MnS access, for example, if a subscription to periodic notification, data, or insights is used; and
iv. any further MnS access details such as the exact MOIs, FQDNs, MIBs, or KPIs that are requested.

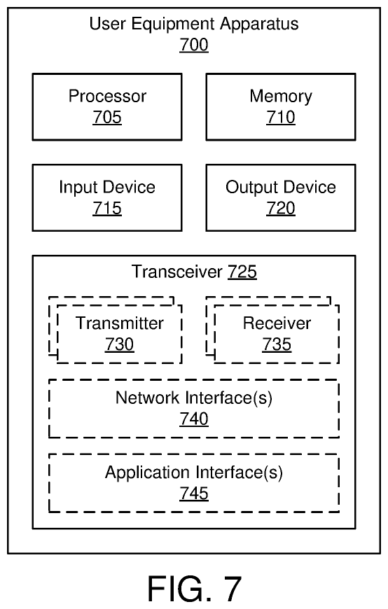

FIG. 7 depicts a user equipment apparatus 700 that may be used for charging third parties for access to management services, according to embodiments of the disclosure. In various embodiments, the user equipment apparatus 700 is used to implement one or more of the solutions described above. The user equipment apparatus 700 may be one embodiment of the remote unit 105 and/or the UE 205, described above. Furthermore, the user equipment apparatus 700 may include a processor 705, a memory 710, an input device 715, an output device 720, and a transceiver 725.

In some embodiments, the input device 715 and the output device 720 are combined into a single device, such as a touchscreen. In certain embodiments, the user equipment apparatus 700 may not include any input device 715 and/or output device 720. In various embodiments, the user equipment apparatus 700 may include one or more of: the processor 705, the memory 710, and the transceiver 725, and may not include the input device 715 and/or the output device 720.

As depicted, the transceiver 725 includes at least one transmitter 730 and at least one receiver 735. In some embodiments, the transceiver 725 communicates with one or more cells (or wireless coverage areas) supported by one or more base units 121. In various embodiments, the transceiver 725 is operable on unlicensed spectrum. Moreover, the transceiver 725 may include multiple UE panel supporting one or more beams. Additionally, the transceiver 725 may support at least one network interface 740 and/or application interface 745. The application interface(s) 745 may support one or more APIs. The network interface(s) 740 may support 3GPP reference points, such as Uu, N1, PC5, etc. Other network interfaces 740 may be supported, as understood by one of ordinary skill in the art.

The processor 705, in one embodiment, may include any known controller capable of executing computer-readable instructions and/or capable of performing logical operations. For example, the processor 705 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725. In certain embodiments, the processor 705 may include an application processor (also known as “main processor”) which manages application-domain and operating system (“OS”) functions and a baseband processor (also known as “baseband radio processor”) which manages radio functions.

The memory 710, in one embodiment, is a computer readable storage medium. In some embodiments, the memory 710 includes volatile computer storage media. For example, the memory 710 may include a RAM, including dynamic RAM (“DRAM”), synchronous dynamic RAM (“SDRAM”), and/or static RAM (“SRAM”). In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data related to charging third parties for access to management services. For example, the memory 710 may store various parameters, panel/beam configurations, resource assignments, policies, and the like, as described above. In certain embodiments, the memory 710 also stores program code and related data, such as an operating system or other controller algorithms operating on the user equipment apparatus 700.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, is designed to output visual, audible, and/or haptic signals. In some embodiments, the output device 720 includes an electronically controllable display or display device capable of outputting visual data to a user. For example, the output device 720 may include, but is not limited to, an LCD display, an LED display, an OLED display, a projector, or similar display device capable of outputting images, text, or the like to a user. As another, non-limiting, example, the output device 720 may include a wearable display separate from, but communicatively coupled to, the rest of the user equipment apparatus 700, such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all or portions of the output device 720 may be integrated with the input device 715. For example, the input device 715 and output device 720 may form a touchscreen or similar touch-sensitive display. In other embodiments, the output device 720 may be located near the input device 715.

The transceiver 725 communicates with one or more network functions of a mobile communication network via one or more access networks. The transceiver 725 operates under the control of the processor 705 to transmit messages, data, and other signals and also to receive messages, data, and other signals. For example, the processor 705 may selectively activate the transceiver 725 (or portions thereof) at particular times in order to send and receive messages.

The transceiver 725 includes at least transmitter 730 and at least one receiver 735. One or more transmitters 730 may be used to provide UL communication signals to a base unit 121, such as the UL transmissions described herein. Similarly, one or more receivers 735 may be used to receive DL communication signals from the base unit 121, as described herein. Although only one transmitter 730 and one receiver 735 are illustrated, the user equipment apparatus 700 may have any suitable number of transmitters 730 and receivers 735. Further, the transmitter(s) 730 and the receiver(s) 735 may be any suitable type of transmitters and receivers. In one embodiment, the transceiver 725 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 725, transmitters 730, and receivers 735 may be implemented as physically separate components that access a shared hardware resource and/or software resource, such as for example, the network interface 740.

In various embodiments, one or more transmitters 730 and/or one or more receivers 735 may be implemented and/or integrated into a single hardware component, such as a multi-transceiver chip, a system-on-a-chip, an ASIC, or other type of hardware component. In certain embodiments, one or more transmitters 730 and/or one or more receivers 735 may be implemented and/or integrated into a multi-chip module. In some embodiments, other components such as the network interface 740 or other hardware components/circuits may be integrated with any number of transmitters 730 and/or receivers 735 into a single chip. In such embodiment, the transmitters 730 and receivers 735 may be logically configured as a transceiver 725 that uses one more common control signals or as modular transmitters 730 and receivers 735 implemented in the same hardware chip or in a multi-chip module.

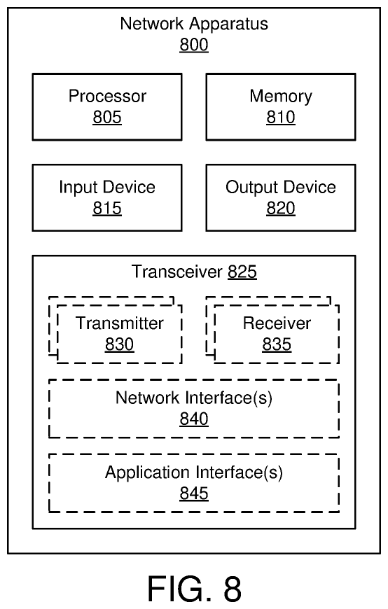

FIG. 8 depicts a network apparatus 800 that may be used for charging third parties for access to management services, according to embodiments of the disclosure. In one embodiment, network apparatus 800 may be one implementation of a RAN node, such as the base unit 121, the RAN node 210, or gNB, described above. Furthermore, the base network apparatus 800 may include a processor 805, a memory 810, an input device 815, an output device 820, and a transceiver 825.

In some embodiments, the input device 815 and the output device 820 are combined into a single device, such as a touchscreen. In certain embodiments, the network apparatus 800 may not include any input device 815 and/or output device 820. In various embodiments, the network apparatus 800 may include one or more of: the processor 805, the memory 810, and the transceiver 825, and may not include the input device 815 and/or the output device 820.

As depicted, the transceiver 825 includes at least one transmitter 830 and at least one receiver 835. Here, the transceiver 825 communicates with one or more remote units 105. Additionally, the transceiver 825 may support at least one network interface 840 and/or application interface 845. The application interface(s) 845 may support one or more APIs. The network interface(s) 840 may support 3GPP reference points, such as Uu, N1, N2 and N3. Other network interfaces 840 may be supported, as understood by one of ordinary skill in the art.

The processor 805, in one embodiment, may include any known controller capable of executing computer-readable instructions and/or capable of performing logical operations. For example, the processor 805 may be a microcontroller, a microprocessor, a CPU, a GPU, an auxiliary processing unit, a FPGA, or similar programmable controller. In some embodiments, the processor 805 executes instructions stored in the memory 810 to perform the methods and routines described herein. The processor 805 is communicatively coupled to the memory 810, the input device 815, the output device 820, and the transceiver 825. In certain embodiments, the processor 805 may include an application processor (also known as “main processor”) which manages application-domain and operating system (“OS”) functions and a baseband processor (also known as “baseband radio processor”) which manages radio function.

In various embodiments, the processor 805 controls the network apparatus 800 to implement the above-described behaviors. In one embodiment, the transceiver 825 receives, at a first entity, a first event notification for generating a charging data record (“CDR”) from a second entity of the communication network, the first event notification received in response to access to a management service of the communication network. In one embodiment, the processor 805 generates, at the first entity, the CDR in response to the first event notification, the CDR comprising information associated with access to the management service of the communication network. In one embodiment, the transceiver 825 transmits, to the second entity, a second event notification comprising the generated CDR.

In one embodiment, the first entity comprises a charging function (“CHF”) and the first event notification comprises a charging data request to the CHF.

In one embodiment, the second entity comprises a charging trigger function (“CTF”) and transmitting the second event notification comprises transmitting a charging data response to the CTF.

In one embodiment, the second entity comprises a charging enablement function (“CEF”) and transmitting the second event notification comprises transmitting a charging data response to the CEF.

In one embodiment, the first event notification for generating the CDR one or more of comprises and is triggered by at least one selected from the group of a number of times a management service of the communication network was accessed over a time interval, changes requested in access to the management service of the communication network and the number of times those changes were requested, types of access to the management service of the communication network, and types of data accessed from the management service of the communication network.

In one embodiment, the types of access to the management service of the communication network comprises a subscription to one or more of periodic notifications, periodic data, and periodic insights.

In one embodiment, the types of data accessed from the management service of the communication network comprises one or more of managed object instances (“MOIs”), fully qualified domain names (“FQDNs”), master information blocks (“MIBS”), and key performance indicators (“KPIs”).

In one embodiment, the processor 805 configures the management service of the communication network to provide charging information for the CDR.

In one embodiment, the processor 805 derives reporting requirements for charging based on existing business level agreements, the business level agreements comprising one or more of service level agreements (“SLAs”), service level specifications (“SLSs”), generic network slice templates (“GSTs”), network slice type (“NEST”), ServiceProfile, and NetworkSlice profile.

In one embodiment, the processor 805 includes in the charging data record charges for possible errors caused in the communication network due to incorrect usage of a management service.

In one embodiment, the transceiver 825 transmits, to an entity of the communication network, a first event notification for generating a charging data record (“CDR”), the first event notification transmitted in response to access to a management service of the communication network. In one embodiment, the transceiver 825 receives a second event notification comprising a generated CDR, the CDR comprising information associated with access to the management service of the communication network.

In one embodiment, the entity comprises a charging function (“CHF”) and the first event notification comprises a charging data request to the CHF.

In one embodiment, the management entity comprises one of a charging trigger function (“CTF”) and a charging enablement function (“CEF”) and transmitting the second event notification comprises transmitting a charging data response to one of the CTF and the CEF.

In one embodiment, the first event notification for generating the CDR one or more of comprises and is triggered by at least one selected from the group of a number of times a management service of the communication network was accessed over a time interval, changes requested in access to the management service of the communication network and the number of times those changes were requested, types of access to the management service of the communication network, types of data accessed from the management service of the communication network.

The memory 810, in one embodiment, is a computer readable storage medium. In some embodiments, the memory 810 includes volatile computer storage media. For example, the memory 810 may include a RAM, including dynamic RAM (“DRAM”), synchronous dynamic RAM (“SDRAM”), and/or static RAM (“SRAM”). In some embodiments, the memory 810 includes non-volatile computer storage media. For example, the memory 810 may include a hard disk drive, a flash memory, or any other suitable non-volatile computer storage device. In some embodiments, the memory 810 includes both volatile and non-volatile computer storage media.

In some embodiments, the memory 810 stores data related to charging third parties for access to management services. For example, the memory 810 may store parameters, configurations, resource assignments, policies, and the like, as described above. In certain embodiments, the memory 810 also stores program code and related data, such as an operating system or other controller algorithms operating on the network apparatus 800.

The input device 815, in one embodiment, may include any known computer input device including a touch panel, a button, a keyboard, a stylus, a microphone, or the like. In some embodiments, the input device 815 may be integrated with the output device 820, for example, as a touchscreen or similar touch-sensitive display. In some embodiments, the input device 815 includes a touchscreen such that text may be input using a virtual keyboard displayed on the touchscreen and/or by handwriting on the touchscreen. In some embodiments, the input device 815 includes two or more different devices, such as a keyboard and a touch panel.

The output device 820, in one embodiment, is designed to output visual, audible, and/or haptic signals. In some embodiments, the output device 820 includes an electronically controllable display or display device capable of outputting visual data to a user. For example, the output device 820 may include, but is not limited to, an LCD display, an LED display, an OLED display, a projector, or similar display device capable of outputting images, text, or the like to a user. As another, non-limiting, example, the output device 820 may include a wearable display separate from, but communicatively coupled to, the rest of the network apparatus 800, such as a smart watch, smart glasses, a heads-up display, or the like. Further, the output device 820 may be a component of a smart phone, a personal digital assistant, a television, a table computer, a notebook (laptop) computer, a personal computer, a vehicle dashboard, or the like.

In certain embodiments, the output device 820 includes one or more speakers for producing sound. For example, the output device 820 may produce an audible alert or notification (e.g., a beep or chime). In some embodiments, the output device 820 includes one or more haptic devices for producing vibrations, motion, or other haptic feedback. In some embodiments, all or portions of the output device 820 may be integrated with the input device 815. For example, the input device 815 and output device 820 may form a touchscreen or similar touch-sensitive display. In other embodiments, the output device 820 may be located near the input device 815.

The transceiver 825 includes at least transmitter 830 and at least one receiver 835. One or more transmitters 830 may be used to communicate with the UE, as described herein. Similarly, one or more receivers 835 may be used to communicate with network functions in the NPN, PLMN and/or RAN, as described herein. Although only one transmitter 830 and one receiver 835 are illustrated, the network apparatus 800 may have any suitable number of transmitters 830 and receivers 835. Further, the transmitter(s) 830 and the receiver(s) 835 may be any suitable type of transmitters and receivers.

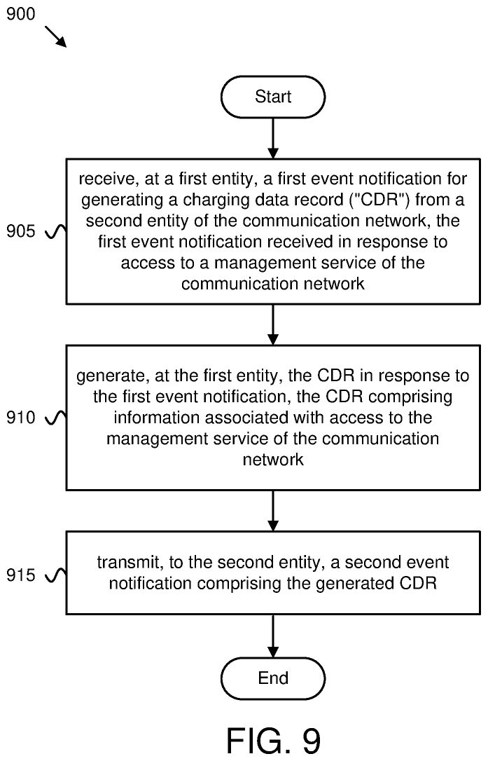

FIG. 9 is a flowchart diagram of a method 900 for charging third parties for access to management services. The method 900 may be performed by a network function of a core network or network entity, for example, a gNB, a base unit and/or other network equipment apparatus 800. In some embodiments, the method 900 may be performed by a processor executing program code, for example, a microcontroller, a microprocessor, a CPU, a GPU, an auxiliary processing unit, a FPGA, or the like.

The method 900, in one embodiment, includes receiving 905, at a first entity, a first event notification for generating a charging data record (“CDR”) from a second entity of the communication network, the first event notification received in response to access to a management service of the communication network. In one embodiment, the method 900 includes generating 910, at the first entity, the CDR in response to the first event notification, the CDR comprising information associated with access to the management service of the communication network. The method 900, in one embodiment, includes transmitting 915, to the second entity, a second event notification comprising the generated CDR. The method 900 ends.

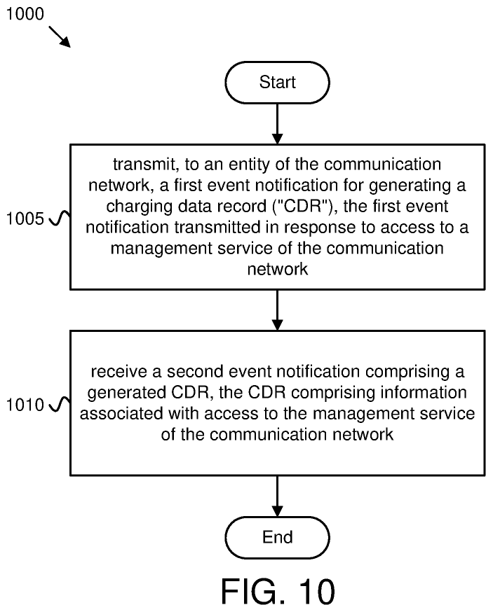

FIG. 10 is a flowchart diagram of a method 1000 for charging third parties for access to management services. The method 1000 may be performed by a network function of a core network or network entity, for example, a gNB, a base unit and/or other network equipment apparatus 800. In some embodiments, the method 1000 may be performed by a processor executing program code, for example, a microcontroller, a microprocessor, a CPU, a GPU, an auxiliary processing unit, a FPGA, or the like.

In one embodiment, the method 1000 includes transmitting 1005, to an entity of the communication network, a first event notification for generating a charging data record (“CDR”), the first event notification transmitted in response to access to a management service of the communication network. In one embodiment, the method 1000 includes receiving a second event notification comprising a generated CDR, the CDR comprising information associated with access to the management service of the communication network. The method 1000 ends.

A first apparatus is disclosed for charging third parties for access to management services. The first apparatus may include a network function of a core network or network entity, for example, a gNB, a base unit and/or other network equipment apparatus 800. In some embodiments, the first apparatus may include a processor executing program code, for example, a microcontroller, a microprocessor, a CPU, a GPU, an auxiliary processing unit, a FPGA, or the like.

In one embodiment, the first apparatus includes a transceiver that receives, at a first entity, a first event notification for generating a charging data record (“CDR”) from a second entity of the communication network, the first event notification received in response to access to a management service of the communication network. In one embodiment, the first apparatus includes a processor that generates, at the first entity, the CDR in response to the first event notification, the CDR comprising information associated with access to the management service of the communication network. In one embodiment, the transceiver transmits, to the second entity, a second event notification comprising the generated CDR.

In one embodiment, the first entity comprises a charging function (“CHF”) and the first event notification comprises a charging data request to the CHF.

In one embodiment, the second entity comprises a charging trigger function (“CTF”) and transmitting the second event notification comprises transmitting a charging data response to the CTF.

In one embodiment, the second entity comprises a charging enablement function (“CEF”) and transmitting the second event notification comprises transmitting a charging data response to the CEF.

In one embodiment, the first event notification for generating the CDR one or more of comprises and is triggered by at least one selected from the group of a number of times a management service of the communication network was accessed over a time interval, changes requested in access to the management service of the communication network and the number of times those changes were requested, types of access to the management service of the communication network, and types of data accessed from the management service of the communication network.

In one embodiment, the types of access to the management service of the communication network comprises a subscription to one or more of periodic notifications, periodic data, and periodic insights.

In one embodiment, the types of data accessed from the management service of the communication network comprises one or more of managed object instances (“MOIs”), fully qualified domain names (“FQDNs”), master information blocks (“MIBS”), and key performance indicators (“KPIs”).

In one embodiment, the processor configures the management service of the communication network to provide charging information for the CDR.

In one embodiment, the processor derives reporting requirements for charging based on existing business level agreements, the business level agreements comprising one or more of service level agreements (“SLAs”), service level specifications (“SLSs”), generic network slice templates (“GSTs”), network slice type (“NEST”), ServiceProfile, and NetworkSlice profile.

In one embodiment, the processor includes in the charging data record charges for possible errors caused in the communication network due to incorrect usage of a management service.

A first method is disclosed for charging third parties for access to management services. The first method may be performed by a network function of a core network or network entity, for example, a gNB, a base unit and/or other network equipment apparatus 800. In some embodiments, the first method may be performed by a processor executing program code, for example, a microcontroller, a microprocessor, a CPU, a GPU, an auxiliary processing unit, a FPGA, or the like.

In one embodiment, the first method includes receiving, at a first entity, a first event notification for generating a charging data record (“CDR”) from a second entity of the communication network, the first event notification received in response to access to a management service of the communication network. In one embodiment, the first method includes generating, at the first entity, the CDR in response to the first event notification, the CDR comprising information associated with access to the management service of the communication network. In one embodiment, the first method includes transmitting, to the second entity, a second event notification comprising the generated CDR.

In one embodiment, the first entity comprises a charging function (“CHF”) and the first event notification comprises a charging data request to the CHF.

In one embodiment, the second entity comprises a charging trigger function (“CTF”) and transmitting the second event notification comprises transmitting a charging data response to the CTF.

In one embodiment, the second entity comprises a charging enablement function (“CEF”) and transmitting the second event notification comprises transmitting a charging data response to the CEF.

In one embodiment, the first event notification for generating the CDR one or more of comprises and is triggered by at least one selected from the group of a number of times a management service of the communication network was accessed over a time interval, changes requested in access to the management service of the communication network and the number of times those changes were requested, types of access to the management service of the communication network, and types of data accessed from the management service of the communication network.

In one embodiment, the types of access to the management service of the communication network comprises a subscription to one or more of periodic notifications, periodic data, and periodic insights.

In one embodiment, the types of data accessed from the management service of the communication network comprises one or more of managed object instances (“MOIs”), fully qualified domain names (“FQDNs”), master information blocks (“MIBS”), and key performance indicators (“KPIs”).

In one embodiment, the first method includes configuring the management service of the communication network to provide charging information for the CDR.

In one embodiment, the first method includes deriving reporting requirements for charging based on existing business level agreements, the business level agreements comprising one or more of service level agreements (“SLAs”), service level specifications (“SLSs”), generic network slice templates (“GSTs”), network slice type (“NEST”), ServiceProfile, and NetworkSlice profile.

In one embodiment, the first method includes in the charging data record charges for possible errors caused in the communication network due to incorrect usage of a management service.

A second apparatus is disclosed for charging third parties for access to management services. The first apparatus may include a network function of a core network or network entity, for example, a gNB, a base unit and/or other network equipment apparatus 800. In some embodiments, the second apparatus may include a processor executing program code, for example, a microcontroller, a microprocessor, a CPU, a GPU, an auxiliary processing unit, a FPGA, or the like.

In one embodiment, the second apparatus includes a transceiver transmits, to an entity of the communication network, a first event notification for generating a charging data record (“CDR”), the first event notification transmitted in response to access to a management service of the communication network. In one embodiment, the transceiver receives a second event notification comprising a generated CDR, the CDR comprising information associated with access to the management service of the communication network.

In one embodiment, the entity comprises a charging function (“CHF”) and the first event notification comprises a charging data request to the CHF.

In one embodiment, the management entity comprises one of a charging trigger function (“CTF”) and a charging enablement function (“CEF”) and transmitting the second event notification comprises transmitting a charging data response to one of the CTF and the CEF.

In one embodiment, the first event notification for generating the CDR one or more of comprises and is triggered by at least one selected from the group of a number of times a management service of the communication network was accessed over a time interval, changes requested in access to the management service of the communication network and the number of times those changes were requested, types of access to the management service of the communication network, types of data accessed from the management service of the communication network.

A second method is disclosed for charging third parties for access to management services. The first method may be performed by a network function of a core network or network entity, for example, a gNB, a base unit and/or other network equipment apparatus 800. In some embodiments, the second method may be performed by a processor executing program code, for example, a microcontroller, a microprocessor, a CPU, a GPU, an auxiliary processing unit, a FPGA, or the like.

In one embodiment, the second method includes transmitting, to an entity of the communication network, a first event notification for generating a charging data record (“CDR”), the first event notification transmitted in response to access to a management service of the communication network. In one embodiment, the second method includes receiving a second event notification comprising a generated CDR, the CDR comprising information associated with access to the management service of the communication network.

In one embodiment, the entity comprises a charging function (“CHF”) and the first event notification comprises a charging data request to the CHF.

In one embodiment, the management entity comprises one of a charging trigger function (“CTF”) and a charging enablement function (“CEF”) and transmitting the second event notification comprises transmitting a charging data response to one of the CTF and the CEF.

In one embodiment, the first event notification for generating the CDR one or more of comprises and is triggered by at least one selected from the group of a number of times a management service of the communication network was accessed over a time interval, changes requested in access to the management service of the communication network and the number of times those changes were requested, types of access to the management service of the communication network, types of data accessed from the management service of the communication network.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A management service (MnS) entity, comprising:
at least one memory; and
at least one processor coupled with the at least one memory and configured to cause the network entity to:
receive a first event notification for generating a charging data record (“CDR”);
generate the CDR in response to the first event notification, the CDR comprising information associated with access to a management service; and
transmit a second event notification comprising the generated CDR.

2. The MnS entity of claim 1, wherein the network entity comprises a charging function (“CHF”) and the first event notification comprises a charging data request to the CHF.

3. The MnS entity of claim 1, wherein transmitting the second event notification comprises transmitting a charging data response to a charging trigger function (“CTF”).

4. The MnS entity of claim 1, wherein transmitting the second event notification comprises transmitting a charging data response to a charging enablement function (“CEF”).

5. The MnS entity of claim 1, wherein the first event notification for generating the CDR is triggered by:
a number of times the management service is accessed over a time interval;
changes requested in access to the management service and a number of times the changes are requested;
types of access to the management service;
types of data accessed from the management service;
or a combination thereof.

6. The MnS entity of claim 5, wherein the types of access to the management service comprises a subscription to one or more of periodic notifications, periodic data, or periodic insights.

7. The MnS entity of claim 5, wherein the types of data accessed from the management service comprises managed object instances (“MOIs”), fully qualified domain names (“FQDNs”), master information blocks (“MIBS”), or key performance indicators (“KPIs”).

8. The MnS entity of claim 1, wherein the at least one processor is configured to cause the network entity to configure the management service to provide charging information for the CDR.

9. The MnS entity of claim 1, wherein the at least one processor is configured to cause the network entity to derive reporting requirements for charging based on existing business level agreements, wherein the business level agreements comprise service level agreements (“SLAs”), service level specifications (“SLSs”), generic network slice templates (“GSTs”), a network slice type (“NEST”), a ServiceProfile, or a NetworkSlice profile.

10. The MnS entity of claim 1, wherein the at least one processor is configured to cause the network entity to include in the charging data record charges for possible errors due to incorrect usage of the management service.

11. A method performed by a management service (MnS) entity, the method comprising:
receiving a first event notification for generating a charging data record (“CDR”);
generating the CDR in response to the first event notification, the CDR comprising information associated with access to a management service; and
transmitting a second event notification comprising the generated CDR.

12. A management service (MnS) entity, the network entity comprising:
at least one memory; and
at least one processor coupled with the at least one memory and configured to cause the network entity to:
transmits a first event notification for generating a charging data record (“CDR”); and
receive a second event notification comprising a CDR, the CDR comprising information associated with access to a management service.

13. The MnS entity of claim 12, wherein the entity comprises a charging function (“CHF”) and the first event notification comprises a charging data request to the CHF.

14. The MnS entity of claim 12, wherein the network entity comprises a charging trigger function (“CTF”) or a charging enablement function (“CEF”) and transmitting the second event notification comprises transmitting a charging data response to one of the CTF or the CEF.

15. The MnS entity of claim 12, wherein the first event notification for generating the CDR is triggered by:
a number of times the management service is accessed over a time interval;
changes requested in access to the management service and a number of times the changes are requested;
types of access to the management service;
types of data accessed from the management service;
or a combination thereof.

16. A processor for wireless communication, comprising:
at least one controller coupled with at least one memory and configured to cause the processor to:
receive a first event notification for generating a charging data record (“CDR”);
generate the CDR in response to the first event notification, the CDR comprising information associated with access to a management service; and
transmit a second event notification comprising the generated CDR.

17. The processor of claim 16, wherein the processor comprises a charging function (“CHF”) and the first event notification comprises a charging data request to the CHF.

18. The processor of claim 16, wherein transmitting the second event notification comprises transmitting a charging data response to a charging trigger function (“CTF”).

19. The processor of claim 16, wherein transmitting the second event notification comprises transmitting a charging data response to a charging enablement function (“CEF”).

20. The processor of claim 16, wherein the first event notification for generating the CDR is triggered by:
a number of times the management service is accessed over a time interval;
changes requested in access to the management service and a number of times the changes are requested;
types of access to the management service;
types of data accessed from the management service;
or a combination thereof.
